(19) United States
(12) Patent Application Publication
(10) Pub. No.: US 2004/0090991 A1
(43) Pub. Date: May 13, 2004

(54) Intelligent network-based system and method for customized program broadcasting and reception

(76) Inventor: Wanda K. Cross, Lynn Center, IL (US)

Correspondence Address: Docket Administrator (Room 3J-219), Lucent Technologies Inc., 101 Crawfords Corner Road, Holmdel, NJ, 07733-3030, US

(21) Appl. No.: 10/289,590

(22) Filed: Nov. 7, 2002

(51) Int. Cl. H04J 1/00

(52) U.S. Cl. 370/486

(57) ABSTRACT

A novel system and method for selecting and receiving multiple electronic programs employs an intelligent service node (ISN) and subscriber database normally associated with intelligent networked telephone systems to allow system subscribers to select from multiple stored or live-broadcast programs to be delivered to a remote reproduction device. The programs can be selected for later playback/broadcast using a variety of devices (such as telephones and PCs) to link to the ISN via a PSTN, the Internet or other means. In the preferred embodiment, the ISN delivers the programs to the reproduction devices, which may be radio receivers, mobile telephones, PCs, and others. The preferred embodiment also contains for each reproduction device, a customized broadcasting module for identifying the subscriber associated with the reproduction device and the program or bundle of programs selected (from those referenced in the subscriber database). The programs can be of a multiple variety, including radio broadcasts, commercial compilations such as the programs of a compact disc, and audio books, as well as audio-visual programs where the reproduction devices contain sufficient bandwidth. The present-inventive system and method also supports live-pause playback of programs.

### BACKGROUND OF THE INVENTION

1. Field of the Invention

The present invention generally relates to systems and methods for broadcasting and receiving multiple electronic programs.

2. Background

Prior art methods of wireless communication between a computer and the Internet can allow an online computer user to listen to live broadcast programs that are not necessarily within the antenna broadcast range of the programs, and download previously recorded programs for current or later viewing/reproduction. However, this requires a full computer which may not be practically operated by a traveling customer at times, or might not always be available to said customer at desirable times. This precludes the reception of programs by devices which are either not computers, or directly attached to computers.

Intelligent Networks (INs) are software and hardware hybrids that are used to automatically process telephone calls in a telephone system. A service control point (SCP) in the IN provides the logic that governs call handling, etc., and contains a database that stores useful information needed for various transactions. The IN also contains several switches for both receiving calls to the network and physically routing calls to destination numbers. Each switch contains a Service Switching Point (SSP) for interfacing with calling parties and performing the actual call routing under the instruction of the SCP.

The SCP and SSP may be connected with a high-speed link utilizing, for example, the Intelligent Network Application Protocol (INAP), as approved by the European Telecommunications Standards Institute (ETSI) or International Telecommunication Unit (ITU). It will be appreciated by those skilled in the art that the SCP can be implemented as a networked database, not limited to one geographic location.

A Service Management System (SMS) is used by customers to establish parameters for various services available, security codes, and any restrictions on the use of a telephone line or account.

An Originating Call Processor (OCP) is part of each switch, and transfers a received call to the switch's SSP. A Terminating Call Processor (TCP) is also part of each switch, and handles the termination of call processing to connect it to the destination number. The interface between the SSP and the OCP, and the interface between the SSP and TCP use a switch internal message flow, or a common channel signaling link or any type of protocol, as will be appreciated by those skilled in the art.

While it is desirable to be able to receive multiple types of electronic programming without the need for a desktop or laptop computer, it is also desirable to receive such programs with the aid of the existing infrastructure of an intelligent-networked telephone network, since such networks are already performing multiple automated functions related to telephone call processing, subscriber account management, and information services.

Prior art digital radio subscriber networks are not comprehensive in scope, as they only allow a subscriber to receive programming from broadcast stations in the network, and not programming from other sources such as stored CDs, DVDs, e-books and the like.

What are therefore highly desirable, but non-existent in the prior art are a comprehensive method and system for allowing multiple users to select and have efficiently delivered, multiple previously recorded or live-broadcast electronic programs in an application service provider environment, regardless of the user's (or the user's listening device) physical location, and importantly, using an intelligent service node of the type used to process telephone call traffic in a telephone network.

### SUMMARY OF THE INVENTION

In view of the aforementioned problems and deficiencies of the prior art, the present invention provides a system for providing to system subscribers, multiple electronic programs. The system at least includes a plurality of program reproduction devices, the reproduction devices being adapted to reproduce programs in a user-perceivable manner, an intelligent service node (ISN) adapted to automatically process communications in the system, the ISN having control logic, a subscriber database coupled to the ISN, the subscriber database being adapted to store for system subscribers, indicia of programs intended to be reproduced by program reproduction devices under the control of subscribers or subscriber agents, and a program library coupled to the ISN, the program library being adapted to store recorded programs and information about broadcast programs. The system further at least includes a source of live broadcast programs, at least one program selection device adapted to communicate with the ISN and select in response to user command, at least one program for later reproduction by a system subscriber, and a customized broadcasting module coupled to each the program reproduction device, the customized broadcasting modules adapted communicate with the ISN including the identity of an associated subscriber, and receive live or recorded programs intended by the associated subscriber or subscriber agent for reproduction.

The present invention also provides a method for providing to subscribers, multiple electronic programs. The method at least includes the steps of, via a plurality of program reproduction devices, reproducing programs in a user-perceivable manner, via an ISN, automatically processing communications, the ISN having control logic, via a subscriber database coupled to the ISN, storing for subscribers, indicia of programs intended to be reproduced by program reproduction devices under the control of subscribers or subscriber agents, and via a program library coupled to the ISN, storing recorded programs and information about broadcast programs. The method at least further includes the steps of providing a source of live broadcast programs, via at least one program selection device, communicating with the ISN and selecting in response to user command, at least one program for later reproduction by a system subscriber, and via a customized broadcasting module coupled to each the program reproduction device, communicating with the ISN including the identity of an associated subscriber, and receiving live or recorded programs intended by the associated subscriber or subscriber agent for reproduction.

### BRIEF DESCRIPTION OF THE DRAWING FIGURE

Features and advantages of the present invention will become apparent to those skilled in the art from the description below, with reference to the following drawing figure, in which:

FIG. 1—the sole drawing figure—is a schematic block diagram of the basic hardware for the intelligent-networked telecommunication system for implementing the present-inventive customized program broadcasting and reception system and method.

### DESCRIPTION OF THE PREFERRED EMBODIMENTS

1. Basic Components and Operation

The present-inventive system and method employ an intelligent service node (ISN) as part of an existing telecommunications system to cause the transmission or downloading of stored or live electronic programs from a variety of storage media or broadcast sources using an application service provider (ASP) approach. As part of an Intelligent Network (IN), the ISN is connected to a subscriber database, for not only storing and modifying subscriber identity information, but also subscriber programming choices for contemporary or future playback.

The ISN is linked to a massive customized broadcast library database for generally storing programs (from a variety of sources such as CDs, electronic novels, and recorded public or private broadcasts) available to subscribers for reception. It is also linked to the public broadcasting system for receiving and retransmitting public broadcasts upon the demand of a user.

The customer can reproduce the desired programming by connecting to the ISN, and communicating the subscriber's identity and choices to the ISN. In the preferred embodiment, the reproduction or listening devices communicate with the ISN via special customized broadcasting modules that transmit to the ISN, the subscriber's service ID and his or her selections for programming reception. The reception link between the reproduction device and the ISN is through telephone via a wide area network (WAN) such as the Internet, or direct connection.

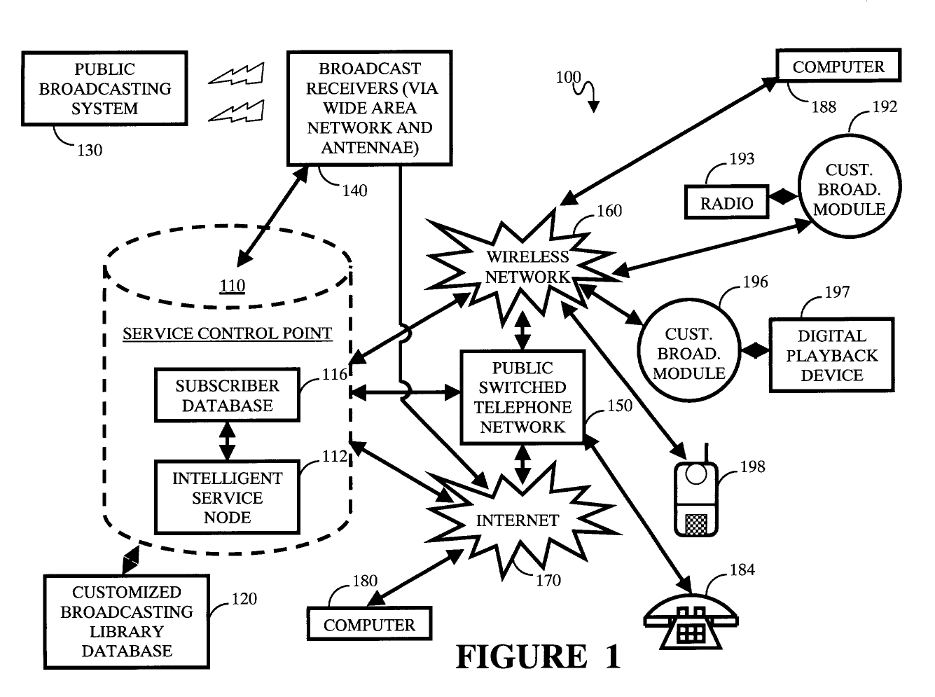

The basic hardware of the customized broadcasting and reception system 100 is illustrated in FIG. 1. The primary portion of the Intelligent Network (IN) is implemented in a Service Control Point (SCP) 110, although the implementation need not be exactly so to comport with the present invention. The SCP 110 contains an Intelligent Service Node (ISN) 112 which performs the system control function, and a subscriber database 116. The subscriber database contains identity and security information for all system subscribers, as well as any custom broadcast selections. In the preferred embodiment, the subscriber database 116 does not contain the actual broadcast program data, but rather links to stored programs and public broadcasts.

Communication in the system 100 is via a variety of means, including a public switched telephone network (PSTN) symbolically represented by the number 150, a wide area network (WAN) such as the Internet symbolically represented by the number 170, and a wireless network symbolically represented by the number 160. Those skilled in the art will understand and appreciate the general operation of these communication systems without the need to provide further details here.

A customized broadcasting library database 120 stores a large catalog of electronic programming content such as music (in compact disc or other digital or audio formats), audio books, stored radio and television (audio portion in the preferred embodiment) broadcasts, etc. The content is cataloged in numerous ways, including artist/author, title, subject, date of release or publishing, publisher, or identity of the broadcasting entity. In the case of public broadcasts, the database 120 stores previous programs of general interest to subscribers or programs that particular subscribers have requested. Additionally, the database 120 keeps track of the scheduling of future broadcasts of interest, along with access information, such as broadcast frequencies, locations and times.

The number 130 symbolically represents the public broadcasting system, from which a subscriber can choose to listen to live programs, or which acts as a source of stored programs for future reproduction. Broadcast receivers 140 receive public broadcasts and direct them to the ISN 112 for selective delivery to subscribers. The broadcasts may be received via the Internet, or via antennae. All communication with the subscriber and the delivery of programs is via the ISN and switches which make up the telephone network.

In operation, a subscriber wishing to access the customized broadcasting service can connect to the ISN via end-user programming devices such as computers 180 or 188 with modems, or telephones 184 or 198. Upon connection to the ISN 112, a subscriber is required to enter an account number and a security code such as a Personal Identification Number (PIN) stored in the subscriber database. If the subscriber is authenticated, he or she can then specify a desire to access the customized broadcasting service. Following a series of menu driven entries, the subscriber can either begin receiving customized programs during the current session, or he or she can specify all or a portion of customized programs for future reception.

The customized programs are received and reproduced for users via a variety of end-user listening devices such as a radio 193, a digital playback device 197, stereo receivers, as well as previously mentioned devices such as computers and cell telephones. The end-user listening devices are attached to special customized broadcasting modules such as the ones numbered 192 and 196. The special customized broadcasting modules communicate with the ISN to indicate the subscriber and security information and the subscriber's program selection information. The customized broadcasting modules are also capable of directly receiving the program data and other program information representing the desired programming, and then outputting the program to the end-user listening device for audible reproduction. It should be appreciated by those skilled in the art that the customized broadcast modules need not be contained in separate packaging, but may be incorporated into the main casing of the end-user listening device when the end-user listening device is specially manufactured.

2. Some Basic Customized Broadcasting Scenarios

Customized Music Broadcasting

A subscriber who travels a great deal can connect to the ISN and preprogram his or her custom broadcast selections for later listening during a future trip or trips. This would free the subscriber from being limited to listening to radio stations and the like while passing through different regions. For example, the subscriber might like to listen to a program of jazz music from the 1980's, or a mix of chosen country/western artists, or a mix of recently released songs from pop musicians. When the subscriber is ready to listen to the pre-selected programs he or she connects to the ISN via a wireless network and a custom broadcast module to begin downloading the programs for listening.

An Alternative to CD Purchases, Audio Books and Cassette Tapes

A subscriber with a large library of CDs can, via the present-inventive customized broadcasting service, listen to all of his favorite CDs and sample others without having to physically load a CD into a playback device. The subscriber can connect to the service and preprogram his or her CDs (stored in the customized broadcasting library) or other compilations for later listening. Moreover, the subscriber is not limited to a particular end-user listening device, and can listen to the CDs from any device having a customized broadcasting module.

The same considerations apply to a subscriber who listens to audio books or cassette tapes. In addition to the not having to retain tapes at every listening location, the subscriber need not be limited to the sometimes poor quality of audio tapes and the concomitant mechanical limitations such as tape tangling.

Receiving Broadcast Programs Outside of Station Broadcast Ranges

A subscriber who often travels may use the present-inventive customized broadcasting service to receive his or her favorite broadcast programs during a trip even when he or she is outside of the terrestrial broadcast range of the associated broadcast stations. By connecting to the service and pre-selecting stations of interest during an upcoming trip, the subscriber can later connect to the service during the trip and listen to the pre-selected stations. The subscriber also has the option to listen to “local” stations as he or she passes through their broadcast areas during the trip.

Live Pause Playback Without Regard to the Particular Listening Device

A subscriber listening to or desiring to listen to certain types of sequential programs such as games and sporting events, or audio novels can pre-select programs for recording (or at least placing a link to a recording) and later listening through the present-inventive customized broadcasting service. For example, a subscriber might know in advance that he or she will not be available to listen to a game during its original broadcast (e.g., he or she is not able to turn on a receiver at the time or is out of normal broadcast range). To later begin listening to the game, the subscriber connects an end-user listening device to the ISN via a customized broadcasting module. After the subscriber account is identified and the appropriate security information is entered, the subscriber can then cause the game to be transmitted to the customized broadcasting module for reproduction by the listening device.

If the subscriber stops listening to the game before it is complete, the customized broadcasting module notes the pause point. Later, the subscriber can resume listening to the game from the pause point, as the customized broadcasting module indicates to the ISN where to resume the playback of the recorded game.

Alternative to the customized broadcasting module storing the pause point, the pause point can be stored by the ISN in the subscriber database.

Playback of the program can start utilizing one end-user listening device, and after playback is paused, can resume on either the same end-user listening device, or any other end-user listening device that has a customized broadcasting module.

Live-pause programming described above is not limited to sporting events, and can be used with many other types of programs, such as audio novels.

Variations and modifications of the present invention are possible, given the above description. However, all variations and modifications which are obvious to those skilled in the art to which the present invention pertains are considered to be within the scope of the protection granted by this Letters Patent.

For example, the programs transmitted and received using the customized broadcasting system and method have heretofore been audio programs. However, audio-visual programs can also be transmitted and received with the inclusion of adequate hardware and communication resources (such as bandwidth).

What is claimed is:

1. A system for providing to system subscribers, multiple electronic programs, said system comprising:
a plurality of program reproduction devices, said reproduction devices being adapted to reproduce programs in a user-perceivable manner;
an intelligent service node (ISN) adapted to automatically process communications in said system, said ISN comprising control logic;
a subscriber database coupled to said ISN, said subscriber database being adapted to store for system subscribers, indicia of programs intended to be reproduced by program reproduction devices under the control of subscribers or subscriber agents;
a program library coupled to said ISN, said program library being adapted to store recorded programs and information about broadcast programs;
a source of live broadcast programs;
at least one program selection device adapted to communicate with said ISN and select in response to user command, at least one program for later reproduction by a system subscriber; and
a customized broadcasting module coupled to each said program reproduction device, the customized broadcasting modules adapted communicate with said ISN including the identity of an associated subscriber, and receive live or recorded programs intended by the associated subscriber or subscriber agent for reproduction.

2. The system of claim 1, wherein communication between said ISN and said customized broadcasting modules is telephonic via a Public Switched Telephone Network (PSTN).

3. The system of claim 1, wherein communication between said ISN and said customized broadcasting modules is telephonic via a Wide Area Network (WAN).

4. The system of claim 1, wherein communication between said ISN and said program selection devices is telephonic via a Public Switched Telephone Network (PSTN).

5. The system of claim 1, wherein communication between said ISN and said program selection devices is telephonic via a Wide Area Network (WAN).

6. The system of claim 1, wherein said recorded programs comprise commercial compilations.

7. The system of claim 1, wherein said source of live broadcast programs comprise programs which are outside of antenna broadcast range.

8. The system of claim 1, wherein said ISN is adapted to provide live-pause programming to said reproduction devices.

9. The system of claim 1, wherein said reproduction devices comprise radio frequency (RF) receivers.

10. The system of claim 1, wherein said program selection devices comprise mobile telephones.

11. A method for providing to subscribers, multiple electronic programs, said method comprising the steps of:
via a plurality of program reproduction devices, reproducing programs in a user-perceivable manner;
via an intelligent service node (ISN), automatically processing communications, said ISN comprising control logic;
via a subscriber database coupled to said ISN, storing for subscribers, indicia of programs intended to be reproduced by program reproduction devices under the control of subscribers or subscriber agents;
via a program library coupled to said ISN, storing recorded programs and information about broadcast programs;
providing a source of live broadcast programs;
via at least one program selection device, communicating with said ISN and selecting in response to user command, at least one program for later reproduction by a system subscriber; and
via a customized broadcasting module coupled to each said program reproduction device, communicating with said ISN including the identity of an associated subscriber, and receiving live or recorded programs intended by the associated subscriber or subscriber agent for reproduction.

12. The method of claim 11, wherein communication between said ISN and said customized broadcasting modules is telephonic via a Public Switched Telephone Network (PSTN).

13. The method of claim 11, wherein communication between said ISN and said customized broadcasting modules is telephonic via a Wide Area Network (WAN).

14. The method of claim 11, wherein communication between said ISN and said program selection devices is telephonic via a Public Switched Telephone Network (PSTN).

15. The method of claim 11, wherein communication between said ISN and said program selection devices is telephonic via a Wide Area Network (WAN).

16. The method of claim 11, wherein said recorded programs comprise commercial compilations.

17. The method of claim 11, wherein said source of live broadcast programs comprise programs which are outside of antenna broadcast range.

18. The method of claim 11, wherein said ISN is adapted to provide live-pause programming to said reproduction devices.

19. The method of claim 11, wherein said reproduction devices comprise radio frequency (RF) receivers.

20. The method of claim 11, wherein said program selection devices comprise mobile telephones.
